(19) United States
(12) Patent Application Publication
(10) Pub. No.: US 2009/0151106 A1
(43) Pub. Date: Jun. 18, 2009

(54) Wiper Assembly

(75) Inventor: John VON STACH, Sault Ste. Marie (CA)

Correspondence Address: GREENBLUM & BERNSTEIN, P.L.C., 1950 ROLAND CLARKE PLACE, RESTON, VA, 20191, US

(73) Assignee: VON STACH MARKETING GROUP INC., Ontario (CA)

(21) Appl. No.: 11/955,789

(22) Filed: Dec. 13, 2007

(51) Int. Cl. B60S 1/28; B60S 1/04; B60S 1/38

(52) U.S. Cl. 15/250.05; 15/250.4

(57) ABSTRACT

A vehicle windshield wiper assembly for providing a vehicle user with a set of windshield wipers for removing grime, insect deposits and other debris off a front windshield of a vehicle. The invention includes a pair of spaced apart wiper blade elements (rubber squeegies) having thin flexible wiping edges with a nylon bristle brush occupying the space between the wiper blade elements said bristle brush making contact with the vehicle windshield as pressure is applied to the wiper assembly.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

This invention relates to windshield wiper systems and more particularly to a windshield wiping system employing a dual purpose scrubber and blade wiping assembly.

### DESCRIPTION OF THE PRIOR ART

Dual purpose scrubber and wiper assemblies have been known wherein a sponge strip is mounted on a wiper blade with the edge of the sponge strip being flush with the edge of the wiper blade.

Attempts have been made to provide a windshield wiper blade assembly for cleaning non-water soluble materials from the windshield as well as wiping water from the windshield. Such devices are commonly shown in U.S. Pat. Nos. 4,327,457, 3,183,816 and 4,567,621 to name but a few examples. While these attempts to provide wiping and cleaning the windshield by means of a scrubbing material between or on one side of a wiping blade, they are not entirely suitable since there exists a considerable gap in the wiping blade assembly where dirt and grime can accumulate and thereby result in smearing.

The object of the present invention is therefore to remedy the disadvantages of the prior art.

### SUMMARY OF THE INVENTION

In accordance with the present invention, a new and improved dual purpose scrubber and wiper assembly is provided for a vehicle windshield wherein the scrubbing and wiping functions complement each other.

It is therefore, one object of the present invention to provide a device for vehicle windshield cleaning which combines the wiping and scrubbing apparatus in an improved manner.

A further object of the present invention is to provide a dual purpose vehicle windshield wiping and scrubbing device which may conveniently and easily be installed and operated on a standard wiper arm assembly as commonly found on vehicles.

A still further object of the present invention is to provide a vehicle windshield wiping and nylon bristle brush for cleaning the windshield of a vehicle of the type including a spring loaded wiper arm for holding the apparatus under pressure against the windshield and oscillating the apparatus across the windshield, said apparatus comprising: attachment means for connecting said apparatus with the wiper arm of the vehicle; a frameless and flexible wiping blade elements carrying member; front and back walls adapted to carry a pair of spaced apart wiping blade elements said blade elements terminating in wiping edges; a space defined by the blade elements, the front and back walls and the carrying member; a nylon bristle brush member adaptedly positioned and carried in the space running from end to end down the centre with equal space on either side of the brush between the blade elements; wherein once the apparatus is securely connected to the wiper arm of the vehicle said apparatus performs a dual cleaning action of wiping and scrubbing the vehicle windshield.

A yet further object of the present invention is to provide a vehicle windshield wiping and scrubbing apparatus for cleaning the windshield of a vehicle of the type including a spring loaded wiper arm for holding the apparatus under pressure against the windshield and oscillating the apparatus across the windshield, said apparatus comprising: attachment means for connecting said apparatus with the wiper arm of the vehicle; a frameless and flexible wiping blade elements carrying member; front and back walls adapted to carry a pair of spaced apart wiping blade elements said blade elements terminating in wiping edges; a space defined by the blade elements, the front and back walls and the carrying member; a nylon bristle brush member comprised of a multitude of individually powered bristles adaptedly positioned and carried in the space said bristles providing rotational scrubbing action said member bristles being powered by connecting the apparatus to the vehicle battery; wherein once the apparatus is securely connected to the wiper arm of the vehicle said apparatus performs a dual cleaning action of wiping and scrubbing the vehicle windshield.

Further objects and advantages of the present invention will become apparent from the following description.

### BRIEF DESCRIPTION OF THE DRAWINGS

FIG. 1 is a perspective view of a windshield wiper assembly for vehicles;

FIG. 2 is a top view of the wiper assembly of the present invention;

FIG. 3 is a bottom view of the wiper assembly of the present invention.

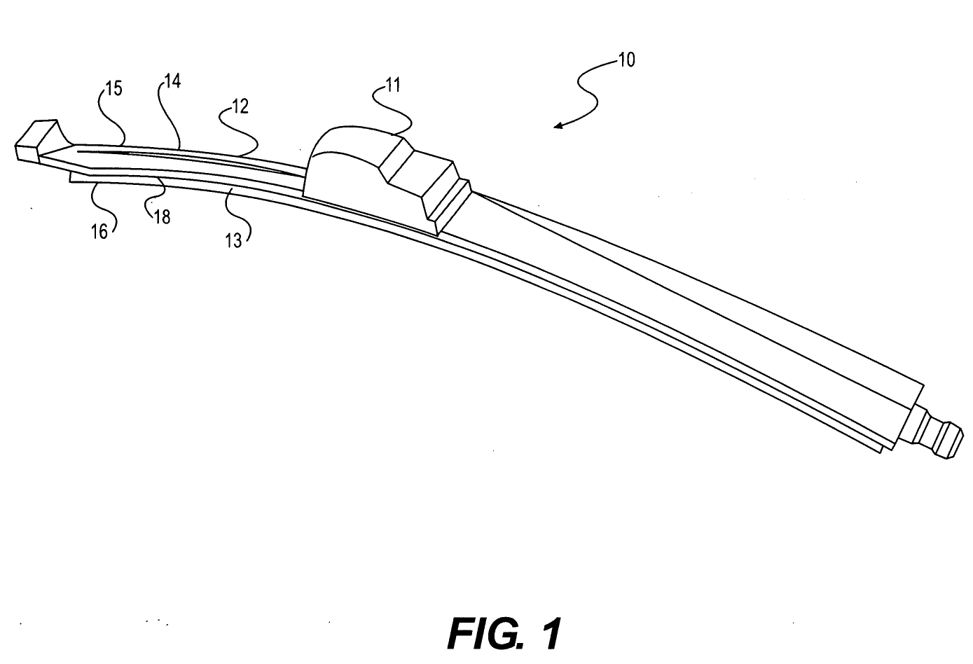

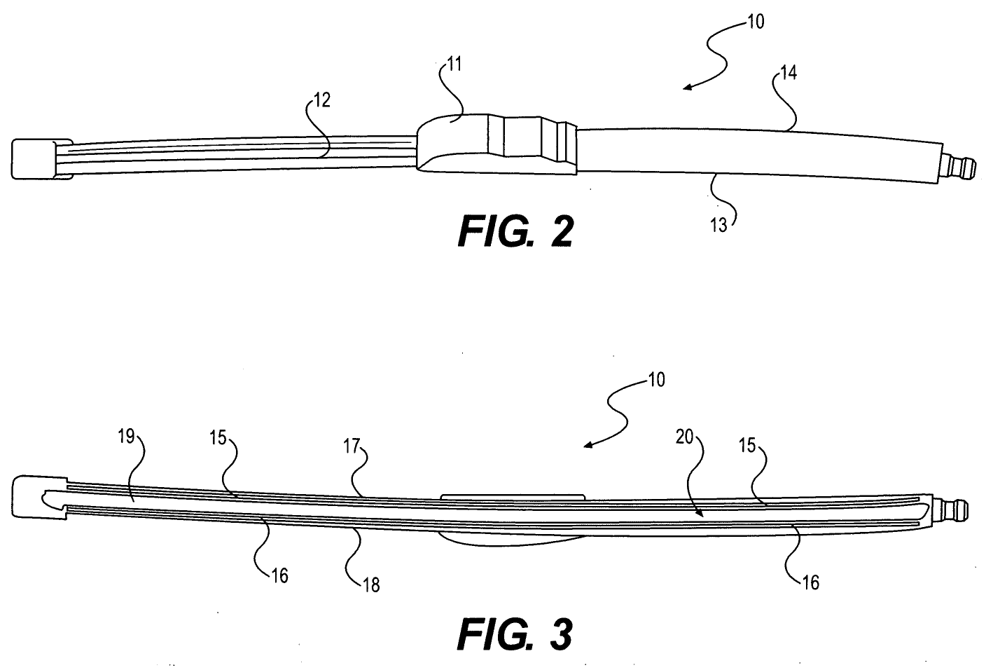

### DETAILED DESCRIPTION OF THE INVENTION

Referring to the drawings, a windshield wiper blade assembly is illustrated and designated generally as 10. The wiper blade assembly 10 may be installed and operated on an oscillating wiper arm said wiper blade assembly 10 being fixedly attached through attachment means 11 which is reciprocally adapted to connect with the wiper arm of a vehicle.

Specifically, the wiper blade assembly 10 is comprised of a frameless and flexible wiping blade elements carrying member 12 with centrally located attachment means 11 to connect said member 12 to the wiper arm of a vehicle. Front wall 13 and back wall 14 are respectively adapted to carry a pair of longitudinally extending spaced apart rubber-like wiping blade elements 15 and 16 terminating in wiping edges 17 and 18 being flexible yet resilient enough to perform wiping of the windshield.

A space 19 is thereby defined between the blade elements 15 and 16, the front wall 13 and the back wall 14 and finally the carrying member 12. An elongated scrubbing material member 20, which is characterized as a nylon bristle brush, is adaptedly positioned and carried in the space 19 between the blade elements 15 and 16. The nylon bristles are independently positioned on a base which slides into and securely attaches into a track which in turn will result in a flexible blade assembly 10 adapted to conform to the vehicle's windshield contour.

In an alternative embodiment of the present invention, it is noted that the scrubbing material member 20 is powered and provides a rotational action or vibration of a multitude of individual bristles providing for enhanced scrubbing performance.

In such case, the power needed for activating the individual bristles of the member 20 is provided by connecting the blade assembly 10 to the vehicle's electrical system.

The blade assembly 10 is flexible and will bend to conform to the vehicle's windshield contour so as to provide even pressure and the proper power required thereby resulting in a co-efficient of friction ideally suited for the blade elements 15 and 16 and the scrubbing material member 20 to perform its wiping and scrubbing functions in contact with the windshield of the vehicle.

The scrubbing material member 20 is characterized by the fact that it is essentially grit-free and will not scratch the windshield glass. The member 20 has a porous structure space running from end to end down the centre with equal space on either side of the brush between the wiping elements.

In a further embodiment of the present invention, the blade assembly 10 is heated through the use of flat electrical elements running the length of said assembly 10 thereby providing even further cleaning power.

In operation, once the blade assembly 10 has been securely mounted to a wiper arm of a vehicle, said blade assembly 10 is moved back and forth across the windshield by the oscillating wiper arm. The scrubbing member 20 against the windshield removes grime, insects and other deposits and debris on the windshield while the blade elements 15 and 16 wiping edges 17 and 18 remove water from the windshield when moving across it.

The compression resulting from connecting the wiper arm with the attachment means 11 of the blade assembly 10 presses the scrubbing member 20 against the windshield said compression being sufficient to maintain the contact between the windshield and the member 20 yet light enough so that the blade elements 15 and 16 wiping edges 17 and 18 and not forced off the windshield.

While a particular embodiment of the present wiper assembly has been described herein, it will be appreciated by those skilled in the art that changes and modifications may be made thereto without departing from the invention in its broader aspects and as set forth in the following claims.

I claim:

1. A vehicle windshield wiping and scrubbing apparatus for cleaning the windshield of a vehicle of the type including a spring loaded wiper arm for holding the apparatus under pressure against the windshield and oscillating the apparatus across the windshield, said apparatus comprising:
attachment means for connecting said apparatus with the wiper arm of the vehicle;
a frameless and flexible wiping blade elements carrying member;
front and back walls adapted to carry a pair of spaced apart wiping blade elements said blade elements terminating in wiping edges;
a space defined by the blade elements, the front and back walls and the carrying member;
an elongated scrubbing material member adaptedly positioned and carried in the space and running from end to end down the centre with equal space on either side of the member between the wiping elements;
wherein once the apparatus is securely connected to the wiper arm of the vehicle said apparatus performs a dual cleaning action of wiping and scrubbing the vehicle windshield.

2. The apparatus of claim 1 wherein said scrubbing member is porous and will not scratch the windshield glass.

3. The apparatus of claim 1 wherein said scrubbing member is a nylon bristle brush.

4. The apparatus of claim 1 wherein the apparatus is heated.

5. A vehicle windshield wiping and scrubbing apparatus for cleaning the windshield of a vehicle of the type including a spring loaded wiper arm for holding the apparatus under pressure against the windshield and oscillating the apparatus across the windshield, said apparatus comprising:
attachment means for connecting said apparatus with the wiper arm of the vehicle;
a frameless and flexible wiping blade elements carrying member;
front and back walls adapted to carry a pair of spaced apart wiping blade elements said blade elements terminating in wiping edges;
a space defined by the blade elements, the front and back walls and the carrying member;
a scrubbing material member comprised of a multitude of individually powered bristles adaptedly positioned and carried in the space said bristles providing rotational scrubbing action said member bristles being powered by connecting the apparatus to the vehicle's electrical system;
wherein once the apparatus is securely connected to the wiper arm of the vehicle said apparatus performs a dual cleaning action of wiping and scrubbing the vehicle windshield.
